(19) United States
(12) Patent Application Publication
(10) Pub. No.: US 2026/0110248 A1
(43) Pub. Date: Apr. 23, 2026

(54) GROUND-HOLE-TUNNEL COMBINED FINE DETECTION METHOD AND SYSTEM

(71) Applicant: SHANDONG UNIVERSITY, Jinan, Shandong (CN)

(72) Inventors: Bin LIU, Jinan (CN); Lei CHEN, Jinan (CN); Yuxiao REN, Jinan (CN); Xinji XU, Jinan (CN); Yang ZZHAO, Jinan (CN); Zhongzhi LI, Jinan (CN)

(73) Assignee: SHANDONG UNIVERSITY, Jinan, Shandong (CN)

(21) Appl. No.: 19/146,151

(22) PCT Filed: Oct. 31, 2023
(86) PCT No.: PCT/CN2023/128707

§ 371 Date: Sep. 4, 2025

(30) Foreign Application Priority Data
Jan. 5, 2023 (CN) 202310011483.4

(51) Int. Cl. E21D 9/00; G01V 1/30

(52) U.S. Cl. CPC E21D 9/003; G01V 1/306

(57) ABSTRACT

A ground-borehole-tunnel combined fine detection method and system, wherein the fine detection method comprises: configuring an ground-borehole-tunnel combined observation mode for tunnel boring machine (TBM) rock-breaking seismic source detection, and carrying out time synchronization and spatial positioning; synchronously acquiring and storing signals by a ground-borehole-tunnel combined detection device when the TBM starts to work; processing parameters in the tunneling process of the TBM and data acquired by a receiving station array to obtain a velocity model and a seismic section of areas in front of and around the tunnel after completing data acquisition; and determining geological conditions of rock masses in front of a working face of the TBM and around the tunnel, based on the obtained velocity model and the seismic section, in combination with the spatial distribution of excavated rock strength indexes and geological drilling data, to realize advanced prediction of geological anomalies.

The present invention claims priority benefits to Chinese Patent Application No. 202310011483.4, filed with the China National Intellectual Property Administration on Jan. 5, 2023 and entitled “GROUND-BOREHOLE-TUNNEL COMBINED FINE DETECTION METHOD AND SYSTEM”, which is incorporated herein by reference in its entirety.

### TECHNICAL FIELD

The present invention belongs to the technical field of seismic wave method detection in advanced geological prediction of tunnel construction, and in particular to a ground-borehole-tunnel combined fine detection method and system.

### BACKGROUND

The description in this section merely provides background information related to the present invention and does not necessarily constitute the prior art.

Underground construction projects such as tunnels have an increasingly high requirement on construction quality, efficiency, and safety. Compared with conventional drilling and blasting methods, tunnel boring machine (TBM) construction has advantages of higher mechanization levels and greater construction efficiency, leading to its expanding application. However, urban underground project construction faces complex and variable geological conditions. Failure to detect and address geological conditions ahead of excavation may trigger disasters such as ground collapse, surface structure collapse, and TBM malfunction under construction disturbance, resulting in project delays, significant environmental impacts, and casualties. Consequently, advanced detection technologies for real-time identification of unfavorable geological bodies in front of the tunneling face, coupled with appropriate mitigation plans and construction solutions, represent effective approaches to prevent such disasters during TBM construction.

In recent years, geophysical advance prediction methods have seen wider application in TBM tunnel constructions. Particularly, seismic wave methods have emerged as one of the most extensively applied techniques for TBM tunnels due to their advantages of high interface imaging accuracy and extended detection range. However, applying seismic wave methods within tunnels requires modifications to conventional seismic wave methods to accommodate the unique tunnel environment. Swedish scholar B. Brodic et al. proposed transmitted wave first break tomography utilizing surface and tunnel observations to locate fault zones. Nevertheless, this method is limited to obtaining only formation information between the ground surface and the upper tunnel section, exhibiting poor response to conditions in front of the tunneling face. During the early 1970s, a cross-hole seismic technology, namely a methodology involving source activation in one borehole and reception in adjacent boreholes, was introduced in oil and gas exploration. While computationally efficient for geological structure detection, this method suffers from insufficient lateral resolution and inadequate boundary delineation capabilities for anomalies. Academician Galperin's 1973 monograph Vertical Seismic Profiling Technology established the foundation for VSP technology. This method provides rich azimuth and offset information, significantly enhancing formation illumination while demonstrating notable advantages in longitudinal resolution. Shandong University developed a ground-tunnel integrated detection method by adapting oilfield seismic-while-drilling technology for tunnel advance prediction. This system employs TBM rock-breaking signals as seismic sources while simultaneously receiving signals both inside the tunnel and on the ground surface, enabling fast seismic wave velocity imaging across an extended area in front of the tunneling face. However, this method is restricted to acquiring reflection data from unfavorable geology in front of the tunneling face, and only acquiring and utilizing specific unfavorable geological information at specific angles limiting its effectiveness for comprehensive, multi-angle imaging of target zone anomalies. Notably, using TBM rock-breaking vibrations as seismic sources yields richer surface wave data on the ground surface. Compared to surface active-source methods for obtaining surface wave signals, the seismic data collected from TBM-induced vibrations features broader frequency bands and more developed higher-order modes, thereby providing more precise underground structural information.

Based on the above, the foregoing methods have respective advantages and disadvantages. Therefore, the above methods are deeply integrated. The more accurate high-quality geological condition may be determined by utilizing the ground surface, the tunnel and the drilling borehole to acquire multi-perspective, multi-wavefield seismic data and describing the unfavorable geology such as boulders and karst from multiple angles. However, due to the special construction environment of urban underground tunnels, there is no related method and technology in the prior art. For the current technical level, there are following problems when data from three observation environments are integrated and utilized for tunnel advance prediction:
(1) Challenges in multi-domain time synchronization: Precise time measurement constitutes the foundation for detection. Integrating ground surface, tunnel, and drilling borehole multi-wavefield data requires precise synchronization of acquisition time under three conditions. However, currently available time synchronization systems fail to meet the precision requirements for such integrated applications.
(2) Difficulties in unfavorable geology response observation in target areas: Constrained by construction environment and observation space, detectors in the tunnel, on the ground surface, and in drilling boreholes are generally in one-dimensional arrangement, the wavefield response acquisition on the unfavorable geology is incomplete, and a specific observation system may only acquire the wavefield response of the specific features.
(3) Difficulties in wavefield separation of multi-perspective wavefield data: Construction environment of urban underground tunnels is complicated, a great amount of interference noise is coupled to acquired seismic records, and the identification of effective information is suppressed, so that it is difficult to extract effective signals from the multi-perspective wavefield data.
(4) Limitations in integrated imaging of multi-perspective wavefield data: Acquisition spatial positions of the multi-perspective wavefield data are difficult, and the unfavorable geological body wavefield features reflected by the data are different. Surface waves and body waves cannot be directly utilized in an integrated manner, and there are few studies on the integrated application of various wavefields and the multi-perspective wavefield data at present. This results in immature joint imaging method.

### SUMMARY

In order to solve the above problems, the present invention provides a ground-borehole-tunnel combined fine detection method and system. According to the present invention, the distribution condition of unfavorable geological bodies in front of the tunneling face can be obtained, the quality grade of the rock mass in front of tunneling can be forecasted, and the unfavorable geological bodies in front of the tunneling face can be found in time.

According to some examples, the present invention adopts the following technical solutions:

A ground-borehole-tunnel combined fine detection method, including:
configuring a ground-borehole-tunnel combined observation mode for a TBM rock-breaking seismic source detection, and carrying out time synchronization and spatial positioning;
synchronously acquiring and storing signals by a ground-borehole-tunnel combined detection device when a TBM starts to work;
processing parameters in the tunneling process of the TBM and data acquired by a receiving station array to obtain a velocity model and a seismic section of areas in front of and around the tunnel after completing data acquisition; and
determining geological conditions of rock masses in front of a working face of the TBM and around the tunnel, based on the obtained velocity model and the seismic section, in combination with the spatial distribution of excavated rock strength indexes and geological drilling data, to realize advanced prediction of geological anomalies.

As an optional implementation, a specific process of configuring the ground-borehole-tunnel combined observation mode for the TBM rock-breaking seismic source detection includes: installing a pilot receiving station array for rock-breaking seismic source onto a support plate behind a TBM cutterhead, arranging a tunnel receiving station array to a middle portion of a TBM body or surrounding rock of tunnel sidewalls, arranging a ground surface receiving station array to a ground surface above an advancing route of the TBM body, fast arranging the ground surface receiving station array at certain channel intervals, and connecting a far-borehole condition geological drilling receiving station array and a near-borehole condition geological drilling receiving station array to an external power supply.

As an optional implementation, when the TBM stops working, the observation mode is quickly configured, or when the TBM works, the tunnel receiving station array, the ground surface receiving station array, the far-borehole condition geological drilling receiving station array and the near-borehole condition geological drilling receiving station array are quickly arranged; and when the TBM stops working, the pilot receiving station array for rock-breaking seismic source is arranged.

As an optional implementation, a specific process of synchronous acquisition by the ground-borehole-tunnel combined detection device includes: when the TBM cutterhead rotates and cuts the rock to generate vibration, the cutterhead rock-breaking vibration is received by a pilot receiving station for rock-breaking seismic source behind the cutterhead, a rock-breaking seismic source simultaneously stimulates seismic waves to diffuse to the front of the working face of the TBM and around the tunnel, the seismic waves are reflected after encountering a wave impedance interface, are received by a tunnel receiving station, a ground surface receiving station and a near-borehole condition geological drilling receiving station buried in a geological drilling borehole behind the wave impedance interface, are transmitted in a position of the wave impedance interface at the same time, and are received by a far-borehole condition geological drilling receiving station buried in a geological drilling borehole in front of the wave impedance interface and the ground surface receiving station, and the pilot receiving station array for rock-breaking seismic source, the tunnel receiving station, the ground surface receiving station array, and the near-borehole condition geological drilling and far-borehole condition geological drilling receiving station arrays automatically store received seismic signals.

As an optional implementation, a seismic record integrated processing method includes:
preprocessing received signals;
performing near-borehole condition fine extraction;
performing far-borehole condition wavefield optimization;
performing face and body wave separation on data acquired by the ground surface receiving station array;
performing cross-correlation and deconvolution processing on seismic source signals and processed received signals;
importing a coordinate of an observation system, and performing automatic first break picking;
performing spectral analysis and band-pass filtering;
performing intra-trace equalization and inter-trace equalization;
suppressing ineffective reflection waves, remaining effective reflection waves, and performing P-wave and S-wave separation;
performing extraction of surface wave frequency dispersion curves, and frequency dispersion of an energy diagram;
performing transmitted wave-surface wave joint inversion on data acquired in an optimized far-borehole condition geological drilling and surface wave data frequency dispersion curves, and acquiring a velocity model in front of the working face of the TBM using a joint inversion method; and
acquiring the seismic section in front of the working face of the TBM using the velocity model acquired through joint inversion and adopting reverse time migration imaging.

As further definition, an objective function of the transmitted wave-surface wave joint inversion is as follows:

$$Φ = \sum {‖ {W}_{d} [ {d}_{o b s} - G ( m ) ] ‖}^{2} + λ {‖ {W}_{c} ( m - {m}_{0} ) ‖}^{2} + β ‖ τ ( m ) ‖ ,$$

wherein, a first item of a right formula is a data fitting item, d_{obs} is an acquired transmitted wave data and extracted surface wave frequency dispersion curve, G(m) is a transmitted wave data and forward frequency dispersion curve obtained through inversion model forward, a second item of the right formula is a model fitting item, m is a model obtained through current inversion, m₀ is an initial model, a third item of the right formula is a cross-gradient item, τ(m)=∇mₚ(x,y,z)×∇mₛ(x,y,z), mₚ represents a P-wave velocity, mₛ represents a S-wave velocity, and W_{d}, W_{c}, λ, and β are respectively weights.

As further definition, a component velocity model respectively adopted by reverse time migration imaging is as follows:

$$E ( v ) = \frac{1}{2} a {‖ {d}_{Sur , obs} - {d}_{Sur , m od} ‖}^{2} + \frac{1}{2} b {‖ {d}_{H o l , o b s} - {d}_{H o l , m o d} ‖}^{2} ,$$

wherein, d_{Sur,obs} and d_{Hol,obs} are respectively seismic data observed in ground surface and far-borehole condition geological drilling boreholes, d_{Sur,mod} and d_{Hol,mod} are respectively ground surface observation seismic data and far-borehole condition geological drilling observation seismic data obtained through forward, and a and b are respectively weights of a minimum error of the ground surface observation data and a minimum error of the far-borehole condition geological drilling observation data.

A ground-borehole-tunnel combined fine detection system, including: a pilot receiving station array for rock-breaking seismic source, a tunnel receiving station array, a ground surface receiving station array, a far-borehole condition geological drilling receiving station array, a near-borehole condition geological drilling receiving station array, a time synchronization system, and a seismic wave data processing instrument system; wherein,
the pilot receiving station array for rock-breaking seismic source is positioned behind a TBM cutterhead, the tunnel receiving station array is installed on a middle portion of a TBM body or surrounding rock of tunnel sidewalls, the ground surface receiving station array is positioned on the ground surface in front of the tunneling face, and the far-borehole and near-borehole condition geological drilling receiving station arrays are positioned inside geological drilling boreholes with different distances in front of the tunneling face;
the time synchronization system is configured to perform precise synchronization on each receiving station array; and
the seismic wave data processing instrument system is configured to receive and store the observation data of each receiving station array and perform fast processing.

The pilot receiving station array for rock-breaking seismic source is positioned behind the TBM cutterhead, and records vibration signals generated when the TBM cutterhead rotates and cuts rock, and the pilot receiving station array is provided with an automatic positioning system, and automatically records a spatial position thereof.

As an optional implementation, the tunnel receiving station array is installed on the TBM body or surrounding rock of tunnel sidewalls, and is configured to receive and store seismic signals reflected to the tunnel sidewalls generated when the cutterhead rock-breaking vibration encounters an unfavorable geological body during transmission in the formation, and the tunnel receiving station array is positioned at two sides of the tunnel and are in linear arrangement.

As an optional implementation, the ground surface receiving station array is positioned on the ground surface in front of the tunneling face, and includes a plurality of ground surface receiving stations, each receiving station is a three-component receiving station, and is configured to receive reflection wave and transmission wave signals when seismic waves generated by rock-breaking vibration of the TBM as a seismic source pass through a wave impedance interface, and surface wave signals generated after the seismic waves are transmitted to the ground surface.

As an optional implementation, the near-borehole condition geological drilling receiving station array is positioned in front of the tunneling face, and is configured to receive and store seismic signals reflected to the geological drilling borehole when the cutterhead rock-breaking vibration encounters an unfavorable geological body during transmission in the formation, and near-borehole condition geological drilling receiving stations are in linear arrangement.

As an optional implementation, the far-borehole condition geological drilling receiving station array is positioned in front of the tunneling face, and is configured to receive and store seismic signals transmitted to the geological drilling borehole when the cutterhead rock-breaking vibration encounters an unfavorable geological body during transmission in the formation, and far-borehole condition geological drilling receiving stations are in linear arrangement.

As an optional implementation, each receiving station array is respectively provided with a time synchronization system, and the time synchronization system unifies the time of each receiving station array through a global positioning system (GPS) signal.

As an optional implementation, data of each receiving station array is transmitted to the seismic wave data processing instrument system, and the seismic wave data processing instrument system is configured to perform integrated processing on the rock-breaking vibration and noise information acquired in the tunnel and on the ground surface to acquire a seismic section of areas in front of and around the tunnel.

As an optional implementation, the pilot receiving station array for rock-breaking seismic source specifically includes pilot receiving stations for rock-breaking seismic source and a support plate, and the pilot receiving stations for rock-breaking seismic source are fixed onto a shield behind the cutterhead through the support plate.

As an optional implementation, the tunnel receiving station array includes a plurality of tunnel receiving stations sequentially fixed to the middle portion of the TBM body or surrounding rock of tunnel sidewalls, each tunnel receiving station respectively includes a three-component receiving station and a fixing device, and the three-component receiving station is fixed onto the TBM or the surrounding rock of the tunnel through the fixing device.

As an optional implementation, the tunnel receiving station array includes two groups of tunnel receiving stations respectively positioned at two sides of the TBM, each group of tunnel receiving stations has a certain distance from the tunneling face, and a certain distance is formed between the two groups of tunnel receiving stations.

As an optional implementation, the ground surface receiving station array includes a plurality of receiving stations sequentially distributed on an advancing route of the TBM body.

As an optional implementation, the time synchronization system includes a plurality of time synchronization hosts respectively connected to the pilot receiving station array for rock-breaking seismic source, the ground surface receiving station array, the tunnel receiving station array, the far-borehole condition geological drilling receiving station array, and the near-borehole condition geological drilling receiving station array.

As an optional implementation, each receiving station is respectively provided with an automatic positioning system.

As an optional implementation, the far-borehole condition geological drilling receiving station array and the near-borehole condition geological drilling receiving station array are pre-buried in the geological drilling boreholes after the excavation of the geological drilling borehole, and the drilling boreholes are filled so that detectors may be in tight contact with surrounding media.

As an optional implementation, each of the pilot receiving station array for rock-breaking seismic source, the ground surface receiving station array, and the tunnel receiving station array is respectively provided with a built-in battery, and the far-borehole condition geological drilling receiving station array, and the near-borehole condition geological drilling receiving station array are provided with external power supplies to realize long-time acquisition.

According to the present invention, when the TBM stops working or starts to work, the observation system is quickly arranged, and multi-angle observation is performed through multi-spatial position combination. In a tunneling process of the TBM, the cutterhead rock-breaking vibration is received by the pilot receiving station for rock-breaking seismic source installed behind the cutterhead, a rock-breaking seismic source simultaneously stimulates seismic waves to diffuse to the front of the working face of the TBM and around the tunnel, and the seismic waves are reflected after encountering a wave impedance interface, are received by a tunnel receiving station, a ground surface receiving station and a near-borehole condition geological drilling receiving station buried in a geological drilling borehole behind the wave impedance interface, are transmitted in a position of the wave impedance interface at the same time, and are received by a far-borehole condition geological drilling receiving station buried in the geological drilling borehole in front of the wave impedance interface and the ground surface receiving station.

The signals are transmitted in real time to the seismic wave data processing instrument system to be processed in real time. By aiming at special conditions of the tunnel forecast, processing methods adapting to respective wavelength features are adopted for different receiving station arrays, the near-borehole condition geological drilling boreholes are subjected to blind deconvolution processing based on time varying wavelets, and the far-borehole condition geological drilling boreholes are subjected to wavefield optimization based on consistent deconvolution and amplitude compensation. The ground surface data is subjected to surface and body separation. Then, wavefield signals are recovered by performing signal interference on seismic source signals acquired by the pilot receiving stations for rock-breaking seismic source and signals acquired by other receiving stations and subjected to denoising. Next, a wave velocity inversion result is obtained through “transmitted wave-surface wave” integrated inversion based on cross gradient, reverse time migration is performed on the basis to generate a seismic section in front of the TBM, so that the quality of the rock masses in front of drilling may be precisely evaluated.

Compared with the prior art, the present invention has the following beneficial effects:
(1) According to the present invention, the advanced geological detection is performed by utilizing the rock-breaking vibration of the TBM, safety and reliability are realized, the normal operation construction of the tunnel is not influenced, the multi-angle seismic observation modes are utilized, the seismic wave receiving stations are seismic wave receiving sensors and are arranged on the ground surface and the side surfaces of the tunnel and in the geological drilling boreholes, and the implementation and application of a tunnel seismic method while drilling are realized. Through the integrated utilization of transmitted waves, reflection waves and surface waves for cross-gradient inversion and reverse time migration imaging, the unfavorable geological body in front of the tunneling face is subjected to all-space detection in aspects of breadth (detection range) and precision, and the all-space rock mass quality in front of the tunneling face is evaluated.
(2) The method and system are particularly applicable to a construction tunnel with characteristics of narrow and small observation space and short detection time, the problem of narrow view is solved, and the occurrence of false alarm and missing alarm phenomena is prevented.
(3) Various kinds of observation systems are adopted to acquire seismic waves from multiple view angles, rich and varied wavefield information is acquired, and the advanced detection is performed using the characteristics of various wavefields.
(4) Special data processing is performed by aiming at different wavefield characteristics, the signal-to-noise ratio of the observation data may be effectively improved, and a realer and more reliable advanced prediction result may be acquired.
(5) The sensitive degrees of different wavefields on the formation information are different, through the ground-borehole-tunnel combined fine detection, various kinds of data may be acquired, the reflection wave information acquired from near-borehole condition geological drilling boreholes and the ground surface is sensitive to the interface information of the unfavorable geological body, the travel time of the transmitted waves acquired from the far-borehole condition geological drilling boreholes and the ground surface is sensitive to the formation velocity change, the precise spatial positioning on the unfavorable geological body may be realized, the precise detection in front of the tunneling face is realized, in addition, through the ground surface data, macroscopic detection may be realized, and the geological condition along the tunnel may be known in advance to guide the tunneling construction.
(6) The rock-breaking vibration of the TBM cutterhead is used as a seismic source, the surface wave data with wide frequency band and complete high-order frequency dispersion curve development may be acquired, and higher-precision inversion imaging may be realized.

To make the foregoing objectives, features, and advantages of the present invention more obvious and understandable, exemplary examples are described in detail as examples below with reference to the accompanying drawings.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation to the present invention.

FIG. 1 is a schematic diagram of a ground-borehole-tunnel combined fine detection system for tunnel construction.

FIG. 2 is a schematic diagram of a working state based on a ground-borehole-tunnel combined fine detection of the tunnel construction.

FIG. 3 is a flowchart of data processing based on the ground-borehole-tunnel combined fine detection of the tunnel construction.

In the figures: 1, TBM cutterhead; 2 three-component seismic station; 3, pilot receiving station array for rock-breaking seismic source; 4, tunnel receiving station array; 5, ground surface receiving station array; 6, near-borehole condition geological drilling receiving station array; 7, far-borehole condition geological drilling receiving station array; 8, time synchronization system; and, 9, seismic wave data processing instrument system.

### DETAILED DESCRIPTION

The present invention will be further illustrated hereafter in combination with accompanying drawings and examples.

It should be pointed out that the following detailed descriptions are all illustrative and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

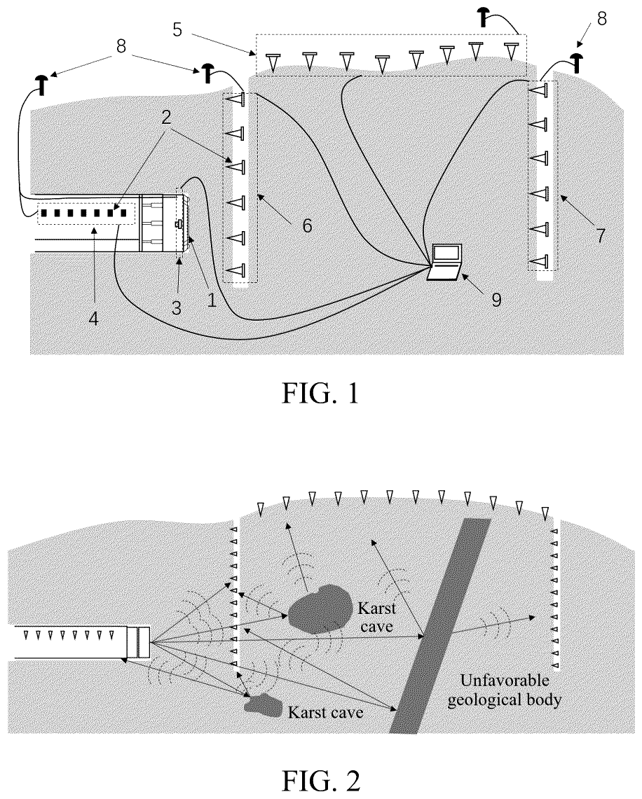

Referring to FIG. 1 showing a schematic diagram of a ground-borehole-tunnel combined fine detection system for tunnel construction, and FIG. 2 showing a schematic diagram of a working state based on ground-borehole-tunnel combined fine detection of tunnel construction.

As shown in FIG. 1, the ground-borehole-tunnel combined fine detection system for tunnel construction mainly includes a pilot receiving station array for rock-breaking seismic source 3, a tunnel receiving station array 4, a ground surface receiving station array 5, a near-borehole condition geological drilling receiving station array 6, a far-borehole condition geological drilling receiving station array 7, a time synchronization system 8, and a seismic wave data processing instrument system 9.

As shown in FIG. 2, as a typical implementation, the pilot receiving station array for rock-breaking seismic source 3 is arranged behind a TBM cutterhead 1 of a TBM body, and is configured to receive vibration generated when the cutterhead 1 rotates and cuts the rock. A pilot receiving station is provided with an automatic positioning system, and its spatial position may be stored. The tunnel receiving station array 4 is arranged on a middle portion of the TBM body or surrounding rock of tunnel sidewalls, and is configured to receive and store seismic signals reflected to the tunnel wall generated when the cutterhead rock-breaking vibration encounters an unfavorable geological body during transmission in the formation. The ground surface receiving station array 5 is installed on the ground surface in front of the working face of the tunnel, is configured to receive and store seismic signals reflected and transmitted to the ground surface generated when the cutterhead 1 rock-breaking vibration encounters an unfavorable geological body during transmission in the formation, and may receive and store surface waves generated by the cutterhead rock-breaking vibration and the environmental noise on the ground surface. The geological drilling receiving station array is arranged in the geological drilling borehole in front of the TBM, the near-borehole condition geological drilling receiving station array 6 and the far-borehole condition geological drilling receiving station array 7 are installed inside geological drilling boreholes with different distances in front of the tunneling face, the near-borehole condition geological drilling receiving station array 6 is configured to receive and store seismic signals reflected to the geological drilling borehole generated when the cutterhead 1 rock-breaking vibration encounters an unfavorable geological body during transmission in the formation, and the far-borehole condition geological drilling receiving station array 7 is configured to receive and store seismic signals transmitted to the geological drilling borehole generated when the cutterhead 1 rock-breaking vibration encounters an unfavorable geological body during transmission in the formation. After the arrangement of each receiving station array is finished, the time synchronization system 8 is started to unify the operation time of each receiving station array. The seismic wave data processing instrument system 9 imports the seismic data received and stored by the pilot receiving station array for rock-breaking seismic source 3, the tunnel receiving station array 4, the ground surface receiving station array 5, the near-borehole condition geological drilling receiving station array 6, and the far-borehole condition geological drilling receiving station array 7, to realize fast automatic processing and acquire the seismic section of areas in front of and around the tunnel.

In different examples, the pilot receiving station array for rock-breaking seismic source is positioned behind the TBM cutterhead, and records vibration signals generated when the TBM cutterhead rotates and cuts rock, and the pilot receiving station array is provided with an automatic positioning system, and may automatically record a spatial position thereof.

The tunnel receiving station array is installed on the TBM body or surrounding rock of tunnel sidewalls, and is configured to receive and store seismic signals reflected to the tunnel sidewalls generated when the cutterhead rock-breaking vibration encounters an unfavorable geological body during transmission in the formation, and the tunnel receiving station array is positioned at two sides of the tunnel and are in linear arrangement.

The ground surface receiving station array is positioned on the ground surface in front of the tunneling face, and includes a plurality of ground surface receiving stations, the ground surface receiving stations may be arranged to present various forms such as a linear form, a square form, a circle form, etc., and each receiving station is a three-component receiving station, and is configured to receive reflection wave and transmission wave signals when seismic waves generated by rock-breaking vibration of the TBM as a seismic source pass through a wave impedance interface, and surface wave signals generated after the seismic waves are transmitted to the ground surface.

The near-borehole condition geological drilling receiving station array is positioned in front of the tunneling face, and is configured to receive and store seismic signals reflected to the geological drilling borehole when the cutterhead rock-breaking vibration encounters an unfavorable geological body during transmission in the formation, and near-borehole condition geological drilling receiving stations are in linear arrangement.

The far-borehole condition geological drilling receiving station array is positioned in front of the tunneling face, and is configured to receive and store seismic signals transmitted to the geological drilling borehole when the cutterhead rock-breaking vibration encounters an unfavorable geological body during transmission in the formation, and far-borehole condition geological drilling receiving stations are in linear arrangement.

Each receiving station array is respectively provided with a time synchronization system, and the time synchronization system unifies the time of each receiving station array through a GPS signal.

Data of each receiving station array is transmitted to the seismic wave data processing instrument system, and the seismic wave data processing instrument system is configured to perform integrated processing on the rock-breaking vibration and noise information acquired in the tunnel and on the ground surface to acquire a seismic section of areas in front of and around the tunnel.

It should be noted that in the art, each receiving station array includes a plurality of receiving stations in one line, including a case in which there is only one line of receiving stations, and each receiving station is a three-component geophone.

A data processing process of the ground-borehole-tunnel combined fine detection of tunnel construction includes: extracting effective signals of ground-borehole-tunnel combined fine detection data of tunnel construction, performing cross-gradient joint inversion on the signals to acquire a S-wave velocity model in front of the tunneling face, and acquiring a seismic section in front of the working face of the TBM by utilizing the velocity model obtained through joint inversion and adopting reverse time migration imaging through cross-correlation imaging conditions.

First, before detection, a ground-borehole-tunnel combined observation mode for TBM rock-breaking seismic source detection is quickly configured. In the present example, the tunnel receiving station array 4 is arranged on the surrounding rock of tunnel sidewalls, the tunnel receiving station array is formed by 6 receiving stations, and the channel interval is 5 m. The ground surface receiving station array 5 are arranged on the ground surface in front of the working face of the TBM. The ground surface receiving station array is formed by 40 ground surface receiving stations, the ground surface receiving station array is fast arranged at a channel interval of 2 m, and in addition, the ground surface receiving stations are provided with automatic positioning systems to automatically store positions. The near-borehole and far-borehole condition geological drilling receiving station arrays 6 and 7 are arranged in near-borehole and far-borehole condition geological drilling boreholes in front of the tunneling face, 30 geological drilling receiving stations are respectively buried in the near-borehole and far-borehole condition geological drilling boreholes, so that the receiving stations are in tight contact with the formation media, and the receiving stations are provided with automatic positioning systems to automatically store positions. After the arrangement of each receiving station array is finished, the time synchronization system 8 is started for time synchronization.

When the TBM starts to work, the cutterhead 1 of the TBM rotates and cuts rock to generate vibration, the cutterhead rock-breaking vibration is received by the pilot receiving station for rock-breaking seismic source 3 behind the cutterhead 1, a rock-breaking seismic source simultaneously stimulates seismic waves to diffuse to the front of the working face of the TBM and around the tunnel, the seismic waves are reflected after encountering a wave impedance interface, and are received by the tunnel receiving station array 4, the ground surface receiving station array 5 and the geological drilling receiving station array 6 buried in the near-borehole condition geological drilling boreholes behind the wave impedance interface, at the same time, the seismic waves are transmitted at the wave impedance interface, and are received by the ground surface receiving station array 5 and the geological drilling receiving station array 7 buried in the far-borehole condition geological drilling boreholes in front of the wave impedance interface, and the ground surface receiving station array also receives the surface waves generated by the cutterhead rock-breaking seismic source and the environmental noise of the ground surface. Information recorded by the pilot receiving station array for rock-breaking seismic source 3, the tunnel receiving station array 4, the ground surface receiving station array 5, the near-borehole condition geological drilling receiving station array 6 and the far-borehole condition geological drilling receiving station array 7 is transmitted to the seismic wave data processing instrument system 9 for automatic integrated processing.

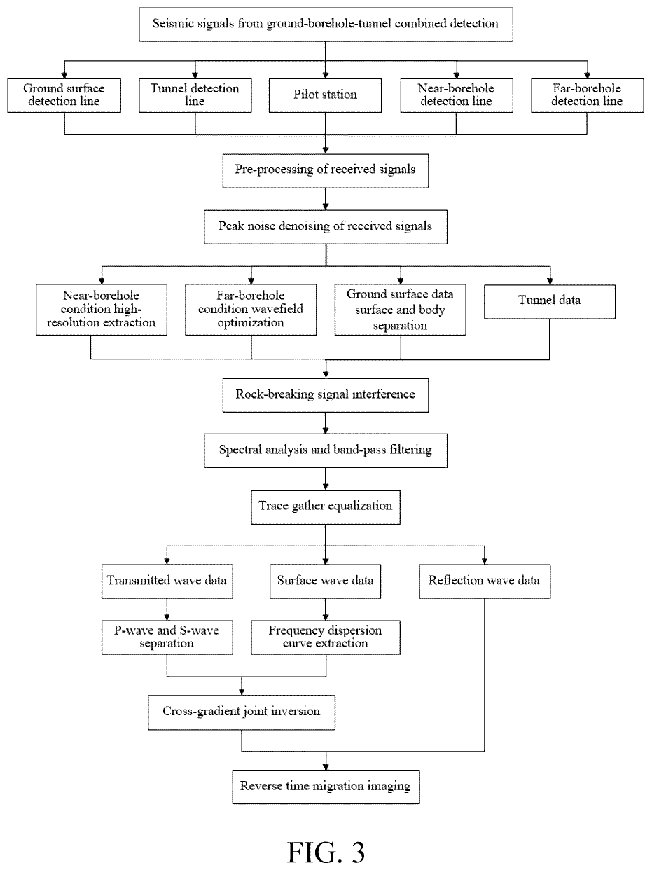

As shown in FIG. 3, a flow process of the seismic record integrated processing includes:
(1) Preprocessing on received signals:
by a band-pass filtering method, instrument noise in signals received by the pilot receiving stations for rock-breaking seismic source, the geological drilling receiving stations, the ground surface receiving stations and the tunnel receiving stations are removed to ensure the quality of the acquired seismic data.
(2) Fixed-point noise denoising on received signals:
in combination with signals received by the pilot receiving stations for rock-breaking seismic source, using a spectral subtraction method, the strong interference noise in the seismic signals received by the tunnel receiving stations and the ground surface receiving stations is attenuated to obtain effective seismic signals through separation;

$$\vert {\hat{S}}_{i} ( ω ) {\vert}^{2} = \vert {Y}_{i} ( ω ) {\vert}^{2} - E [ \vert N ( ω ) \vert ] ,$$

wherein, |Ŝᵢ(ω)|² is a power spectrum of pure seismic signals, E[|N(ω)|] is a mathematical expectation of a noise power spectrum, and |Yᵢ(ω)|² is a power spectrum of original noise-containing seismic signals.
(3) Extraction of near-borehole body wave information:
By aiming at the problems that the reflection wavefield recovery of the ground surface and near-borehole drilling boreholes is influenced by transmission distance, the wavelet form variation is great, and the difference is obvious, a blind deconvolution method based on time varying wavelets is implemented, and a high-resolution data extraction is realized. First, the signals received from the near-borehole condition geological drilling boreholes after denoising processing are subjected to generalized S transform to obtain a seismic record time-frequency spectrum, then, the time-frequency wavelet amplitude spectrum obtained through spectral simulation is subjected to inverse Fourier transform to obtain time-varying wavelets, blind deconvolution is performed, and the data resolution is improved.
(4) Far-borehole wavefield optimization:
The quality of the far-borehole observation data is poor, the seismic record has low dominant frequency and narrow band width, the long-distance energy attenuation is serious, through comprehensive consideration on factors such as shot points, detection points and migration distances, first, the signals received from the far-borehole condition geological drilling boreholes after the denoising processing are subjected to frequency compensation based on consistency deconvolution, then, the amplitude compensation is performed based on inverse Q filtering, and the resolution of the observation data is improved.
(5) Surface and body separation:
The data acquired by the ground surface receiving station array simultaneously includes seismic waves generated by the cutterhead rock-breaking seismic source, surface waves and background noise, so surface and body separation is needed, and the sufficient utilization on the acquired data is realized.
(6) Rock-breaking signal interference:
The seismic source signals and the received signals subjected to denoising processing are subjected to cross-correlation and deconvolution processing, incoherent noise may be further attenuated, the rock-breaking vibration signals may be compressed into equivalent pulse signals to realize unconventional rock-breaking seismic source interference, and the conversion from the unconventional rock-breaking seismic source seismic records to the conventional seismic source seismic records is completed.
(7) Observation system importing and first break picking:
Relative coordinates of the receiving station for rock-breaking seismic source, the tunnel receiving station array, the receiving station array in geological drilling boreholes and the ground surface receiving station array are imported, the receiving moments of first break waves arriving at the geological drilling boreholes and the ground surface are picked using an automatic first break picking method, and in addition, the wave velocity is calculated using the relative distance and the first break wave arrival moments.
(8) Spectral analysis and band-pass filtering:
The seismic records of the time domain are transformed to those of the frequency domain through Fourier transform, the noise signals at different frequency bands are removed through band-pass filtering, the frequency band of effective reflection waves are remained, finally, the seismic records of the frequency domain are transformed to those of the time domain through Fourier inversion transform, and the signal-to-noise ratio of the seismic records is improved.
(9) Trace gather equalization:
Steps of intra-trace equalization and inter-trace equalization are included. Intra-trace equalization refers to compressing waves with strong shallow layer energy in each tunnel, enhancing waves with deep portion energy, and controlling the amplitude of the shallow layer and deep layer seismic waves to be within a certain dynamic range. Inter-trace equalization mainly aims at eliminating the differences of energy stimulated by different seismic source points, so that the amplitude of the reflection waves is not influenced by stimulation conditions, but only reflects geological structure conditions.
(10) Effective signal extraction and P-wave and S-wave separation:
Interference waves and ineffective reflection waves behind the working face of the TBM are suppressed using f-k and τ-p integrated filtering, at the same time, direct waves are removed, only effective reflection waves from the front and the lateral side of the working face of the TBM are remained, automatic extraction is performed, in addition, P-waves, SH-waves and SV-waves in the three-component seismic records are separated at the f-k domain or τ-p domain, and the migration imaging and geological explanation in a next step may be conveniently carried out.
(11) Extraction of surface wave frequency dispersion curves:
The seismic records after body wave removal are transformed to the f-v domain using a frequency-Bezier transform method to obtain a frequency dispersion energy diagram, and multi-modal frequency dispersion curves are extracted from the frequency dispersion energy diagram.
(12) “Transmitted wave-surface wave” joint inversion based on cross gradient:
The frequency dispersion curves of surface wave data and data acquired from the far-borehole condition geological drilling boreholes subjected to wavefield optimization are imported, and are subjected to “transmitted wave-surface wave” joint inversion, and a velocity model in front of the working face of the TBM is acquired using a joint inversion method.
An objective function of the “transmitted wave-surface wave” cross-gradient joint inversion is as follows:

$$Φ = \sum {‖ {W}_{d} [ {d}_{o b s} - G ( m ) ] ‖}^{2} + λ {‖ {W}_{c} ( m - {m}_{0} ) ‖}^{2} + β ‖ τ ( m ) ‖ ,$$

wherein, a first item of a right formula is a data fitting item, d_{obs} is an acquired transmitted wave data and extracted surface wave frequency dispersion curve, G(m) is a transmitted wave data and forward frequency dispersion curve obtained through inversion model forward, a second item of the right formula is a model fitting item, m is a model obtained through current inversion, m₀ is an initial model, a third item of the right formula is a cross-gradient item, τ(m)=∇mₚ(x,y,z)×∇mₛ(x,y,z), mₚ represents a P-wave velocity, mₛ represents a S-wave velocity, and W_{d}, W_{c}, λ, and β are respectively weights.
(13) Reverse time migration imaging:
The seismic section in front of the working face of the TBM is acquired using the velocity model acquired through joint inversion and adopting reverse time migration imaging through cross-correlation imaging conditions.
A component velocity model adopted by reverse time migration is as follows:

$$E ( v ) = \frac{1}{2} a {‖ {d}_{Sur , obs} - {d}_{Sur , mod} ‖}^{2} + \frac{1}{2} b {‖ {d}_{H o l , o b s} - {d}_{H o l , m o d} ‖}^{2} ,$$

wherein, d_{Sur,obs} and d_{Hol,obs} are respectively seismic data observed in ground surface and far-borehole condition geological drilling boreholes, d_{Sur,mod} and d_{Hol,mod} are respectively ground surface observation seismic data and far-borehole condition geological drilling observation seismic data obtained through forward, and a and b are respectively weights of a minimum error of the ground surface observation data and a minimum error of the far-borehole condition geological drilling observation data.
The cross-correlation imaging conditions are as follows:

$$I ( x , y , z ) = {\int }_{0}^{T} S ( x , y , z , t ) \cdot R ( x , y , z , t ) dt ,$$

wherein, I(x,y,z) represents an imaging result, S(x,y,z,t) represents a seismic source wavefield, R(x,y,z,t) represents a detector wavefield, and T is a total time length of migration.

The foregoing descriptions are merely exemplary examples of the present invention, but are not intended to limit the present invention. A person skilled in the art may make various alterations and variations to the present invention. Any modification, equivalent replacement, or improvement, etc. made within the spirit and principle of the present invention by a person skilled in the art without creative efforts shall fall within the protection scope of the present invention.

1. A ground-borehole-tunnel combined fine detection method, comprising:
configuring a ground-borehole-tunnel combined observation mode for a tunnel boring machine (TBM) rock-breaking seismic source detection, and carrying out time synchronization and spatial positioning;
synchronously acquiring and storing signals by a ground-borehole-tunnel combined detection device when a TBM starts to work;
processing parameters in the tunneling process of the TBM and data acquired by a receiving station array to obtain a velocity model and a seismic section of areas in front of and around the tunnel after completing data acquisition; and
determining geological conditions of rock masses in front of a working face of the TBM and around the tunnel, based on the obtained velocity model and the seismic section, in combination with the spatial distribution of excavated rock strength indexes and geological drilling data, to realize advanced prediction of geological anomalies; wherein:
a seismic record integrated processing method comprises:
preprocessing received signals;
performing near-borehole condition fine extraction;
performing far-borehole condition wavefield optimization;
performing face and body wave separation on data acquired by the ground surface receiving station array;
performing cross-correlation and deconvolution processing on seismic source signals and processed received signals;
importing a coordinate of an observation system, and performing automatic first break picking;
performing spectral analysis and band-pass filtering;
performing intra-trace equalization and inter-trace equalization;
suppressing ineffective reflection waves, remaining effective reflection waves, and performing P-wave and S-wave separation;
performing extraction of surface wave frequency dispersion curves, and frequency dispersion of an energy diagram;
performing transmitted wave-surface wave joint inversion on data acquired in an optimized far-borehole condition geological drilling and surface wave data frequency dispersion curves, and acquiring a velocity model in front of the working face of the TBM using a joint inversion method; and
acquiring the seismic section in front of the working face of the TBM using the velocity model acquired through joint inversion and adopting reverse time migration imaging;
wherein, an objective function of the transmitted wave-surface wave joint inversion is as follows:
$$Φ = \sum {‖ {W}_{d} [ {d}_{o b s} - G ( m ) ] ‖}^{2} + λ {‖ {W}_{c} ( m - {m}_{0} ) ‖}^{2} + β ‖ τ ( m ) ‖ ;$$
wherein, a first item of a right formula is a data fitting item, d_{obs} is an acquired transmitted wave data and extracted surface wave frequency dispersion curve, G(m) is a transmitted wave data and forward frequency dispersion curve obtained through inversion model forward, a second item of the right formula is a model fitting item, m is a model obtained through current inversion, m₀ is an initial model, a third item of the right formula is a cross-gradient item, τ(m)=∇mₚ(x,y,z)×∇mₛ(x,y,z), my represents a P-wave velocity, mₛ represents a S-wave velocity, and W_{d}, W_{c}, λ, and β are respectively weights.

2. The ground-borehole-tunnel combined fine detection method according to claim 1, wherein a specific process of configuring the ground-borehole-tunnel combined observation mode for the TBM rock-breaking seismic source detection comprises: installing a pilot receiving station array for rock-breaking seismic source onto a support plate behind a cutterhead of the TBM, arranging a tunnel receiving station array to a middle portion of a TBM body or surrounding rock of tunnel sidewalls, arranging a ground surface receiving station array to a ground surface above an advancing route of the TBM body, fast arranging the ground surface receiving station array at certain channel intervals, and connecting a far-borehole condition geological drilling receiving station array and a near-borehole condition geological drilling receiving station array to an external power supply.

3. The ground-borehole-tunnel combined fine detection method according to claim 1, wherein when the TBM stops working, the observation mode is quickly configured, or when the TBM works, the tunnel receiving station array, the ground surface receiving station array, the far-borehole condition geological drilling receiving station array and the near-borehole condition geological drilling receiving station array are quickly arranged; and when the TBM stops working, the pilot receiving station array for rock-breaking seismic source is arranged.

4. The ground-borehole-tunnel combined fine detection method according to claim 1, wherein a specific process of synchronous acquisition by the ground-borehole-tunnel combined detection device comprises: when the cutterhead of the TBM rotates and cuts the rock to generate vibration, the cutterhead rock-breaking vibration is received by the pilot receiving station for rock-breaking seismic source installed behind the cutterhead, a rock-breaking seismic source simultaneously stimulates seismic waves to diffuse to the front of the working face of the TBM and around the tunnel, the seismic waves are reflected after encountering a wave impedance interface, are received by a tunnel receiving station, a ground surface receiving station and a near-borehole condition geological drilling receiving station buried in a geological drilling borehole behind the wave impedance interface, are transmitted in a position of the wave impedance interface at the same time, and are received by a far-borehole condition geological drilling receiving station buried in a geological drilling borehole in front of the wave impedance interface and the ground surface receiving station, and the pilot receiving station array for rock-breaking seismic source, the tunnel receiving station, the ground surface receiving station array, and the near-borehole condition geological drilling and far-borehole condition geological drilling receiving station arrays automatically store received seismic signals.

5-6. (canceled)

7. The ground-borehole-tunnel combined fine detection method according to claim 1, wherein a component velocity model respectively adopted by reverse time migration imaging is as follows:
$$E ( v ) = \frac{1}{2} a {‖ {d}_{Sur , obs} - {d}_{Sur , m od} ‖}^{2} + \frac{1}{2} b {‖ {d}_{H o l , o b s} - {d}_{H o l , m o d} ‖}^{2} ;$$
wherein, d_{Sur,obs} and d_{Hol,obs} are respectively seismic data observed in ground surface and far-borehole condition geological drilling boreholes, d_{Sur,mod} and d_{Hol,mod} are respectively ground surface observation seismic data and far-borehole condition geological drilling observation seismic data obtained through forward, and a and b are respectively weights of a minimum error of the ground surface observation data and a minimum error of the far-borehole condition geological drilling observation data.

8. A ground-borehole-tunnel combined fine detection system, comprising: a pilot receiving station array for rock-breaking seismic source, a tunnel receiving station array, a ground surface receiving station array, a far-borehole condition geological drilling receiving station array, a near-borehole condition geological drilling receiving station array, a time synchronization system, and a seismic wave data processing instrument system; wherein,
the pilot receiving station array for rock-breaking seismic source is positioned behind a cutterhead of a tunnel boring machine (TBM), the tunnel receiving station array is installed on a middle portion of a TBM body or surrounding rock of tunnel sidewalls, the ground surface receiving station array is positioned on the ground surface in front of the tunneling face, and the far-borehole and near-borehole condition geological drilling receiving station arrays are positioned inside geological drilling boreholes with different distances in front of the tunneling face;
the time synchronization system is configured to perform precise synchronization on each receiving station array; and
the seismic wave data processing instrument system is configured to receive and store the observation data of each receiving station array and perform fast processing; wherein:
a seismic record integrated processing method comprises:
preprocessing received signals;
performing near-borehole condition fine extraction;
performing far-borehole condition wavefield optimization;
performing face and body wave separation on data acquired by the ground surface receiving station array;
performing cross-correlation and deconvolution processing on seismic source signals and processed received signals;
importing a coordinate of an observation system, and performing automatic first break picking;
performing spectral analysis and band-pass filtering;
performing intra-trace equalization and inter-trace equalization;
suppressing ineffective reflection waves, remaining effective reflection waves, and performing P-wave and S-wave separation;
performing extraction of surface wave frequency dispersion curves, and frequency dispersion of an energy diagram;
performing transmitted wave-surface wave joint inversion on data acquired in an optimized far-borehole condition geological drilling and surface wave data frequency dispersion curves, and acquiring a velocity model in front of the working face of the TBM using a joint inversion method; and
acquiring the seismic section in front of the working face of the TBM using the velocity model acquired through joint inversion and adopting reverse time migration imaging;
wherein, an objective function of the transmitted wave-surface wave joint inversion is as follows:
$$Φ = \sum {‖ {W}_{d} [ {d}_{o b s} - G ( m ) ] ‖}^{2} + λ {‖ {W}_{c} ( m - {m}_{0} ) ‖}^{2} + β ‖ τ ( m ) ‖ ;$$
wherein, a first item of a right formula is a data fitting item, d_{obs} is an acquired transmitted wave data and extracted surface wave frequency dispersion curve, G(m) is a transmitted wave data and forward frequency dispersion curve obtained through inversion model forward, a second item of the right formula is a model fitting item, m is a model obtained through current inversion, m₀ is an initial model, a third item of the right formula is a cross-gradient item, τ(m)=∇mₚ(x,y,z)×∇mₛ(x,y,z), my represents a P-wave velocity, mₛ represents a S-wave velocity, and W_{d}, W_{c}, λ, and β are respectively weights.

9. The ground-borehole-tunnel combined fine detection system according to claim 8, wherein the pilot receiving station array for rock-breaking seismic source is positioned behind the cutterhead of the TBM, and records vibration signals generated when the cutterhead of the TBM rotates and cuts rock, and the pilot receiving station array is provided with an automatic positioning system, and automatically records a spatial position thereof.

10. The ground-borehole-tunnel combined fine detection system according to claim 8, wherein the tunnel receiving station array is installed on the TBM body or surrounding rock of tunnel sidewalls, and is configured to receive and store seismic signals reflected to the tunnel sidewalls generated when the cutterhead rock-breaking vibration encounters an unfavorable geological body during transmission in the formation, and the tunnel receiving station array is positioned at two sides of the tunnel and are in linear arrangement.

11. The ground-borehole-tunnel combined fine detection system according to claim 8, wherein the ground surface receiving station array is positioned on the ground surface in front of the tunneling face, and comprises a plurality of ground surface receiving stations, each receiving station is a three-component receiving station, and is configured to receive reflection wave and transmission wave signals when seismic waves generated by rock-breaking vibration of the TBM as a seismic source pass through a wave impedance interface, and surface wave signals generated after the seismic waves are transmitted to the ground surface.

12. The ground-borehole-tunnel combined fine detection system according to claim 8, wherein the near-borehole condition geological drilling receiving station array is positioned in front of the tunneling face, and is configured to receive and store seismic signals reflected to the geological drilling borehole when the cutterhead rock-breaking vibration encounters an unfavorable geological body during transmission in the formation, and near-borehole condition geological drilling receiving stations are in linear arrangement.

13. The ground-borehole-tunnel combined fine detection system according to claim 8, wherein the far-borehole condition geological drilling receiving station array is positioned in front of the tunneling face, and is configured to receive and store seismic signals transmitted to the geological drilling borehole when the cutterhead rock-breaking vibration encounters an unfavorable geological body during transmission in the formation, and far-borehole condition geological drilling receiving stations are in linear arrangement.

14. The ground-borehole-tunnel combined fine detection system according to claim 8, wherein each receiving station array is respectively provided with a time synchronization system, and the time synchronization system unifies the time of each receiving station array through a GPS signal; and
the time synchronization system comprises a plurality of time synchronization hosts respectively connected to the pilot receiving station array for rock-breaking seismic source, the ground surface receiving station array, the tunnel receiving station array, the far-borehole condition geological drilling receiving station array, and the near-borehole condition geological drilling receiving station array.

15. The ground-borehole-tunnel combined fine detection system according to claim 8, wherein data of each receiving station array is transmitted to the seismic wave data processing instrument system, and the seismic wave data processing instrument system is configured to perform integrated processing on the rock-breaking vibration and noise information acquired in the tunnel and on the ground surface to acquire a seismic section of areas in front of and around the tunnel.

16. The ground-borehole-tunnel combined fine detection system according to claim 8, wherein each receiving station is respectively provided with an automatic positioning system.
